(19) United States
(12) Patent Application Publication
(10) Pub. No.: US 2025/0257754 A1
(43) Pub. Date: Aug. 14, 2025

(54) REVERSIBLY ATTACHABLE BAYONET FITTING

(71) Applicant: SHELL USA, INC., Houston, TX (US)

(72) Inventors: Remco SCHILTHUIZEN, Amsterdam (NL); Edwim MAAS, Houston, TX (US)

(21) Appl. No.: 18/703,030

(22) PCT Filed: Nov. 2, 2022
(86) PCT No.: PCT/US2022/079108

§ 371 Date: Apr. 19, 2024

Related U.S. Application Data
(60) Provisional application No. 63/274,680, filed on Nov. 2, 2021.

(51) Int. Cl. F16B 21/04

(52) U.S. Cl. CPC F16B 21/04

(57) ABSTRACT

The invention relates to a bayonet assembly (20) comprising the bayonet fitting (1) and an attachment support (21), wherein the attachment support (21) comprises a domed bayonet recess (24), a bayonet cut-out (25), and more than one dimple (26); wherein the number of more than one dimple (26) of the bayonet assembly is the same as the number of more than one protuberance (7) of the bayonet assembly; wherein in a first orientation the bayonet fitting (1) and the attachment support (21) are detachable from each other, and in a second orientation the bayonet fitting (1) and the attachment support (21) are lockable to each other; and wherein in the second orientation, each of the more than one dimple (26) reversibly accommodates each of the more than one protuberance (7).

### FIELD OF THE INVENTION

The invention relates to a reversibly attachable bayonet fitting (1). The invention also relates to a bayonet assembly (20). The invention additionally relates to the use of a bayonet fitting (1) for the reversible attachment and detachment of internals within reactor vessels, distillation columns and mass transfer units. The invention further relates to the use of a bayonet assembly (20), for the reversible attachment and detachment of internals within reactor vessels, distillation columns and mass transfer units.

### BACKGROUND OF THE INVENTION

Bayonet fittings are known in the art. They enable the reversible connection of two pieces, for example two sections of piping, a lightbulb to its fitting socket, or a camera's lense to the camera body. Bayonet fittings comprise a locking mechanism, which when engaged, prevents the locked pieces from separating, unless knowingly unlocked by a user, thus providing a level of security during the operation of assemblies comprising multiple parts.

An example of assemblies comprising multiple parts can be found in, for example, within vessels such as reactor units, distillation columns and mass transfer units used in plants in the chemicals, petrochemical and hydrocarbon processing industries.

Typically, such reactor units, distillation columns and/or mass transfer units comprise an outer casing, made usually from steel, to contain the materials and substances that are to be separated (in the case of distillation columns), to be reacted together (in the case of reactor units), and/or mass/energy transferred (in the case of mass transfer units). Various inlets and outlets enable the input and output of materials from these vessels. Such vessels may differ in size, for example, their diameters may range from 1 m to 10 m.

The efficiency of such vessels depend on their internal architecture. Such architecture comprises elements such as plates, distribution devices, collecting devices, separation devices, contacting devices, mixing and/or mass transfer devices that, at least, mix, separate and/or distribute the contents of the vessel, all of which need to be attached to one another and/or to the internal side of the vessels at precise locations, as well as detached from one another during maintenance, modification and/or decommissioning. These elements are generally referred to as ‘internals’, and is referred to hereinafter as “internals”.

Assembly of the internal architecture of such vessels is a complex operation. This complexity is usually exacerbated by the inaccessibility of the locations where attachments are required to be fitted. One way to overcome said inaccessibility is by the use of blind connections. Blind connections may be effected by, for example, bolts that are irreversibly attached to an attachment support of the vessel. Their irreversible attachment may be effected by welding bolt heads to the non-lumen side of the attachment support, before the attachment support is placed into the vessel. The required internals may then be hung onto these bolts, and the assembly secured by screwing nuts onto the threads of the bolts, and tightening them.

However, irreversible attachment bolts are particularly disadvantageous if they need to be removed, for example if modification of the internal structure is required, or during maintenance, as their removal will require drilling out of the bolt, which can damage the location where it was attached. Further, harsh operating environments that can exist in such vessels (e.g. due to high temperatures, high pressures, extreme pH, carbonisation of the contents, etc.), which can chemically and physically damage the bolts and their nuts, making their unfastening or removal difficult.

An additional disadvantage presented by bolting internals is that bolting prevents movement of the internals caused by their thermal expansion/contraction.

Therefore, there is a need for a fastening means that can be a reversibly attached, for example, to a vessel's attachment support, from which internals can be also reversibly detached.

Further, there is a need for a fastening means that does not impede thermal expansion/contraction of internals that are attached to them.

The present inventors have sought to find a reversibly attachable fastening means that does not require welding, from which internals can be reversibly attached and detached, and one that does not impede thermal expansion and/or contraction of internals.

### SUMMARY OF THE INVENTION

Accordingly, the present invention concerns a bayonet fitting (1) comprising a head section (2), a base section (3), and a clamping section (13); wherein the head section (2) and the base section (3) and the clamping section are a single contiguous piece; wherein the head section (2) comprises a cylindrical core (5) that protrudes along the longitudinal axis (A-A) of the bayonet fitting; wherein the cylindrical core (5) comprises more than one flange (6) protruding radially from the circumferential surface (12) of the cylindrical core (5) in a direction perpendicular to the longitudinal axis of the bayonet fitting; wherein each of the more than one flange (6) comprises the clamping section (13) and an apex (14); wherein the base section (3) comprises an inner facing side (8) from which the cylindrical core (5) protrudes, and an outer facing side (9) that faces the opposite direction to the cylindrical core (5) along the longitudinal axis of the bayonet fitting (A-A); wherein the surface profile of the inner facing side (8) is convex; wherein the surface profile of the outer facing side (9) is flat; wherein the inner facing side (8) further comprises more than one protuberance (7) emerging off the inner facing side (8) in a direction parallel to the longitudinal axis of the bayonet fitting (A-A); wherein the apex points towards the inner facing side (8) of the base section; and wherein the clamping section (13) comprises the apex (14), the inner facing side (8) of the base section (3) and a protuberance (7).

The invention also relates to a bayonet assembly (20) comprising the bayonet fitting (1) and an attachment support (21), wherein the attachment support (21) comprises a domed bayonet recess (24), a bayonet cut-out (25), and more than one dimple (26); wherein the number of more than one dimple (26) of the bayonet assembly is the same as the number of more than one protuberance (7) of the bayonet assembly; wherein in a first orientation the bayonet fitting (1) and the attachment support (21) are detachable from each other, and in a second orientation the bayonet fitting (1) and the attachment support (21) are lockable to each other; and wherein in the second orientation, each of the more than one dimple (26) reversibly accommodates each of the more than one protuberance (7).

The invention additionally relates to the use of a bayonet fitting (1) for the reversible attachment and detachment of internals within reactor vessels and distillation columns.

The invention further relates to the use of a bayonet assembly (20), for the reversible attachment and detachment of internals within reactor vessels and distillation columns.

### BRIEF DESCRIPTION OF THE DRAWINGS

FIG. 1 illustrates perspective view of the first embodiment of the bayonet fitting according to the present invention.

FIG. 2 illustrates perspective view of an embodiment of the bayonet assembly according to the present invention.

FIG. 3 illustrates a side view of the first embodiment of the bayonet fitting according to the present invention, showing the head section (2), the base section (3) and the clamping section (13).

FIG. 4 illustrates a perspective view of attachment support (21).

FIG. 5 illustrates perspective view of the fifth embodiment of the bayonet fitting according to the present invention.

FIG. 6 illustrates perspective view of the sixth embodiment of the bayonet fitting according to the present invention.

### DETAILED DESCRIPTION OF THE INVENTION

The present inventors have sought to find a reversibly attachable and detachable fastening means for vessels such as, but limited to, industrial reactor vessels, distillation columns and mass transfer units that enable blind-fastening of internals, whilst not requiring any welding steps to attach or detach internals, from which vessel internals can be securely attached and removed without difficulty or without the use of tools to apply force, and one that is compatible with the thermal expansion and/or contraction of internals.

The present invention provides a bayonet fitting (1) comprising a head section (2), a base section (3), and a clamping section (13), wherein the head section (2), the base section (3) and the clamping section are a contiguous single piece.

The bayonet fitting (1) may further comprise a tail section (4) that protrudes from the base section (3) in an opposite direction to the head section (2) along the longitudinal axis of the bayonet fitting (A-A), and when the tail section (4) is present, the head section (2), the base section (3), the clamping section and the tail section (4) are a contiguous single piece.

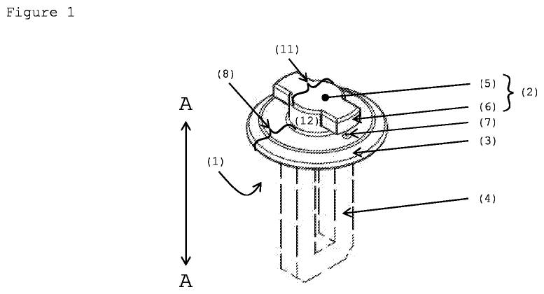

The direction of the longitudinal axis of the bayonet fitting is illustrated in FIG. 1, where it is represented by the two-way arrow in the direction ‘A-A’.

The bayonet fitting has rotational symmetry around the longitudinal axis of the bayonet fitting (A-A), such that the longitudinal axis of the bayonet fitting runs through the center of the head section, the base section, and the tail section (when present).

Herein, a direction that is perpendicular to the longitudinal axis of the bayonet fitting means a direction that is around 90° off the direction of the longitudinal axis of the bayonet fitting.

The head section (2) comprises a cylindrical core (5) that protrudes along the longitudinal axis of the bayonet fitting (A-A), sharing a common rotational axis with the base section (3) along said longitudinal axis.

The base section (3) comprises an inner facing side (8) from which the cylindrical core (5) protrudes, and an outer facing side (9) that faces an opposite direction to the cylindrical core (5) along the longitudinal axis of the bayonet fitting (A-A). When present, the tail section (4) contiguously protrudes from the outer facing side (9) of the base section (3).

A side view transverse section profile of the inner facing side (8) is substantially convex, and the side view transverse section profile of the outer facing side (9) is flat. The reference herein to ‘substantially convex’ surface profile refers to a surface that has an overall dome shaped protrusion emerging off the base section, which in general follows elements of an elliptical or circular direction, where the surface further comprises a flatter plateau region, as well as a corrugated region comprising at least one concentric ridge, groove and/or a wrinkle. Thus, the cut-through transverse profile of the base section (3) is not a smooth dome, but comprises the plateau region, and the corrugated region comprising at least one concentric ridge, groove and/or a wrinkle.

The cylindrical core (5) of the head section comprises a first surface (10) that faces towards, and is contiguous with, the inner facing side (8) of the base section, and a second surface (11) that faces in the opposite outward direction to the base section (3) along the longitudinal axis of the bayonet fitting (A-A). The cylindrical core (5) further comprises a circumferential surface (12) the runs along the outer flat edge of the cylindrical core.

The cylindrical core (5) of the head section comprises more than one flange (6) protruding radially from its circumferential surface (12) in a direction perpendicular to the longitudinal axis of the bayonet fitting. ‘More than one’ flange, in the context herein, is preferably two flanges, however, more than two flanges is not precluded.

The rim that follows the circumference of the second surface (11) and around perimeter of the more than one flange (6) may be beveled to reduce the sharpness of the rim.

In the context of a head section comprising two ‘more than one flange’, an axis connects and runs through the radially outward facing tips of the each more than one flange, in a direction perpendicular to the longitudinal axis of the bayonet fitting; such axis is referred herein as the ‘flange tip axis’.

Viewed end-on along the flange tip axis, each of the more than one flange (6) presents a first side (18) that has its exposed surface on the same lateral plane, and contiguous with, the second surface (11) of the cylindrical core (5), and two sides that are parallel to each other ((16) and (17)) that run from the first side (18) towards the inner facing side (8) of the base section. The the two parallel sides ((16) and (17)) also protrude outwards from the cylindrical core's circumferential surface (12), in a direction perpendicular to the longitudinal axis of the bayonet fitting (A-A). A fourth side (15) of each flange faces the inner facing side (8) of the base section.

Each of the more than one flange (6) has a height H1 measured from the first side (18) in a direction parallel to the longitudinal axis of the bayonet fitting (A-A) towards and up to the end of its most distal part (this part is referred to hereinafter as an ‘apex’ (14) of the gradient/dome/triangle—see below) of the fourth side (15). The height (H1) of each of the more than one flange (6) is the same.

The cylindrical core (5) has a height H2 measured from the second surface (11) in a direction parallel to the longitudinal axis of the bayonet fitting (A-A) towards and up to the inner facing side (8) of the base section.

The height H1 of each of the more than one flange (6) is less than the height H2 of the cylindrical core (5). The height difference provides a gap, referred to hereinafter as a clamping section (13), of height H3, which is also the distance between the apex (14) of each of the more than one flange and the inner facing side (8) of the base section. Thus, the clamping section (13) comprises the apex (14, see below) and the inner facing side (8) of the base section (3), and further comprises more than one protuberance (7, see below).

In a first embodiment of the bayonet fitting, viewed end-on along the flange tip axis, the side profile of each of the more than one flange (6) is a trapezoid (30), wherein said side profile is presented by the combination of the first side (18) and the two parallel sides ((16) and (17) (which together form a cuboid or an oblong sub-section part of the trapezoid), and further by the side profile of the fourth side (15).

The side profile of the fourth side (15) is angled to comprise a gradient, with respect to the lateral plane of the first side (18). The gradient completes the trapezoid profile as viewed from the side profile of each of the more than one flange (6). The gradient leads the surface of the fourth side (15) up to an apex (14) of the trapezoid. The apex (14) of the trapezoid points towards the inner facing side (8) of the base section, and the side of the fourth side (15) where the apex (14) is located is closer to the inner facing side (8) of the base section, than on its non-apex side.

The gradient also provides a leading edge to the fourth side (15). Preferably, the angle of the gradient (θ¹), measured from the perpendicular axis to the longitudinal axis of the bayonet fitting, is at most 10°, more preferably the angle of the gradient is at most 8°, even more preferably the angle of the gradient is at most 6°. Preferably the angle of the gradient (measured from the perpendicular axis to the longitudinal axis of the bayonet fitting) is at least 1°, more preferably the angle of the gradient is at least 3°, even more preferably the angle of the gradient is at least 4°. Preferably range of the angle of the gradient is 1° to 10°, more preferably range of the angle of the gradient is 3° to 8°, even more preferably the range of angle of the gradient is 4° to 6°. The angle of the gradient (θ¹) of each of the more than one flange (6) is the same.

In the first embodiment of the bayonet fitting, the clamping section (13) (of height H3) is formed by the space between the apex (14) of the gradient and the inner facing side (8) of the base section. Thus, the clamping section (13) comprises the apex (14) and the inner facing side (8) of the base section (3), and further comprises a protuberance (7, see below).

In a second embodiment of the bayonet fitting, viewed end-on along the flange tip axis, the end-on side profile of the fourth side (15) is a dome (31), wherein the curved surface of the dome comprises a varying/curved gradient extending (14) up to an apex (14) of the dome that faces towards the inner facing side (8) of the base section.

As with the first embodiment, the combination of the remaining sides (i.e. the first side (18) and the two parallel sides ((16) and (17))) together form a cuboid or an oblong sub-section that makes up the rest of the end-on side profile of each of the more than one flange (6).

The dome's curved gradient on the fourth side (15) provides a leading edge to the fourth side (15).

In the second embodiment of the bayonet fitting, the clamping section (13) (of height H3) is formed by the space between the apex (14) of the dome and the inner facing side (8) of the base section. Thus, the clamping section (13) comprises the apex (14) and the inner facing side (8) of the base section (3), and further comprises a protuberance (7) (see below).

The area bound by the diameter of the dome over the fourth side (15) may cover a substantial proportion of the surface of the fourth side (15), or may be as small as a pimple.

In a third embodiment of the bayonet fitting, viewed end-on along the flange tip axis, the end-on side profile of the fourth side (15) is a triangle (32).

As with the first embodiment, the combination of the remaining sides (i.e. the first side (18) and the two parallel sides ((16) and (17))) together form a cuboid or an oblong sub-section that makes up the rest of the end-on side profile of each of the more than one flange (6).

The triangle profile of the fourth side (15) comprises an apex (14) that points towards the inner facing side (8) of the base section.

One of the external faces of the triangular profile is a leading edge, and the other is a trailing edge. The leading edge and the trailing edge may have equal lengths, or one may be longer than the other. Where the leading edge and the trailing edge have equal lengths, an isosceles triangle is formed.

The leading edge comprises a gradient on the surface of the fourth side (15), with respect to the lateral plane of the first side (18). The end-on side profile of the fourth side (15) is preferably an isosceles triangle, wherein preferably the angle of the gradient (θ²), measured from the perpendicular axis to the longitudinal axis of the bayonet fitting, is at most 20°, more preferably the angle of the gradient is at most 16°, even more preferably the angle of the gradient is at most 12°. Preferably the angle of the gradient (measured from the perpendicular axis to the longitudinal axis of the bayonet fitting) is at least 2°, more preferably the angle of the gradient is at least 6°, even more preferably the angle of the gradient is at least 8°. Preferably range of the angle of the gradient is 2° to 20°, more preferably range of the angle of the gradient is 6° to 16°, even more preferably the range of angle of the gradient is 8° to 12°. The angle of the gradient (θ²) of the leading edge of each of the more than one flange (6) is the same.

In the third embodiment of the bayonet fitting, the clamping section (13) (of height H3) is formed by the space between the apex (14) of the triangle and the inner facing side (8) of the base section. Thus, the clamping section (13) comprises the apex (14) and the inner facing side (8) of the base section (3), and further comprises a protuberance (7, see below).

In the first, second and the third embodiments, each of the more than one flange (6) comprises an apex (14), wherein each apex points towards the inner facing side (8) of the base section.

In the first, second and the third embodiments, the clamping section (13) of the bayonet fitting (1) comprises the apex (14) and the inner facing side (8) of the base section (3), and further comprises a protuberance (7, see below).

The inner facing side (8) of the base section comprises more than one protuberance (7) emerging off the inner facing side in a direction parallel to the longitudinal axis of the bayonet fitting (A-A). The number of the more than one protuberance (7) is equal to the number of the more than one flange (6). Each of the more than one protuberance (7) is a pimple-like protrusion, which is located within the clamping section (13), pointing towards the fourth side (15) of each of the more than one flange (7), such that when the bayonet fitting is viewed end-on along the longitudinal axis of the bayonet fitting (A-A), from the second surface (11) end, the view of the of more than one protuberance (7) is restricted by each of the more than one flange (6), as each of the more than one protuberance sits under the ‘shadow’ of, or behind/under, each of the more than one flange (6).

In a fourth embodiment of the bayonet fitting, the bayonet fitting does not comprise a tail section (4).

The fourth embodiment may comprise the features of any one of the first, second or third embodiments.

In a fifth embodiment of the bayonet fitting, the tail section (4) is an arch, wherein the u-shaped profile of the arch is oriented such that its u-bend side protrudes away (in a direction along the longitudinal axis of the bayonet fitting (A-A)) from the base section (3) of the bayonet fitting. Conversely, the terminal ends of the arms of the arch are attached to the outer facing side (9) of the base section, forming a contiguous single piece with the base section (3) and the head section (2).

An ‘arch plane’ is referred to herein as the plane that proceeds through the arch when the arch is placed flat on its wide side, being parallel to the surface on which the wide side of the arch is rested upon.

In the context of a head section comprising two ‘more than one flange’, the arch tail section (4) is oriented on the outer facing side (9) of the base section, and its rotational orientation is such that the arch plane is at 90° (ninety degrees) to the flange tip axis when viewed along the longitudinal axis of the bayonet fitting (A-A).

The fifth embodiment may comprise the features of any one of the first, second or third embodiments.

In a sixth embodiment of the bayonet fitting, the tail section (4) is a stud bolt, wherein a screw-threaded body is attached to the outer facing side (9) of the base section, and protrudes away (in a direction along the longitudinal axis of the bayonet fitting (A-A)) from the base section (3) of the bayonet fitting, forming a single contiguous piece with the base section (3) and the head section (2). Standard washer(s) and nut(s) may be fitted/threaded onto its screw-threaded body.

The screw-threaded body of the stud bolt comprises two parallel sections wherein the screw thread is shaved off along the screw-threaded body's longitudinal axis. This enables the stud-bolt to pass through a rectangular opening where two sides of the rectangle opening are separated by a distance that is less than the diameter of the screw-threaded body, but more than the distance that separates the shaved off sides.

When placed on a horizontal surface, such that one shaved off face sits flat on the horizontal surface, the second shaved off face is directly above it, also presenting a horizontal face that is parallel to the horizontal plane on which the screw-threaded body of the stud bolt is sitting on. In this orientation, the perimeters of the two shaved off faces, and their horizontal planes, are also parallel to each other, and they have substantially the same shaved off surface area.

A flat plane runs horizontally through middle of the screw-threaded body of the stud bolt, parallel to the horizontal planes of the shaved off faces, and this is referred to herein as the ‘bolt plane’.

In the context of a head section comprising two ‘more than one flange’, the stud bolt tail section (4) is oriented on the outer facing side (9) of the base section such that the rotational orientation of the bolt plane is at 90° (ninety degrees) to the flange tip plane.

The sixth embodiment may comprise the features of any one of the first, second or third embodiments.

The present invention also relates to a bayonet assembly (20). The bayonet assembly comprises an attachment support (21) and the bayonet fitting (1) of the present invention, as described herein.

The bayonet fitting (1) is attachable to, and detachable from, the attachment support (21).

Attachment supports (21), otherwise, also referred to as ‘base panels’, sit within the lumen of reactors and columns, usually adjacent to such vessels' main casing, or main wall, as a first layer towards the center of the vessel, and provide a platform onto which the internals can be attached. The vessel design may dictate other locations within the vessel where the attachment supports may sit.

The overall external shape, or outline, of the attachment support will depend on where and how, it is to be fitted within a reactor or column, and is not part of the invention.

The attachment support (21) comprises a reactor lumen facing side (22) and a reactor casing facing side (23).

To enable the attachment of the bayonet fitting (1) to the attachment support (21), the attachment support comprises a domed bayonet recess (24). Each attachment support comprises at least one domed bayonet recess (24).

The domed bayonet recess (24) comprises a cavity that dips from the reactor lumen facing side (22) of the attachment support towards the reactor casing facing side (23) of the attachment support.

The domed bayonet recess (24) comprises a bayonet cut-out (25), which is a hole through center of the domed bayonet recess (24). The perimeter outline of the bayonet cut-out (25) is the same plan-view shape as the outline shape of the combination of the cylindrical core (5) and the more than one flange (6), such that in a first orientation of the bayonet fitting (1) in relation to the attachment support (20), the cylindrical core (5) and the more than one flange (6) can pass unimpeded through the bayonet cut-out (25), however, their further passage in said direction is impeded when the inner facing side (8) of the base section rests against the domed bayonet recess (24). The domed bayonet recess (24) further comprises more than one dimple (26)

The domed bayonet recess (24) and the bayonet cut-out (25), can be made in the attachment support (21) by, for example, but not limited to, a punch process, which not only forms the domed bayonet recess (24), but also can punch the hole to form the bayonet cut-out (25).

The cut-through transverse profile of the domed bayonet recess (24) follows the same cut-through transverse profile of inner facing side (8) of the base section, such that, the plateau region and the corrugated region comprising the at least one concentric ridge, groove and/or a wrinkle of the inner facing side (8) of the base section are replicated (as if a relief impression of them were taken by the bayonet recess), and they are snugly houseable within the domed bayonet recess (24).

The overall depth of the domed bayonet recess (24) taking the flat profile of the reactor lumen facing side (22) of the attachment support as a base and measuring towards the reactor casing facing side (23) of the attachment support has the same numeric value as the overall height of the base section (3) of the bayonet fitting, such that in both the first orientation and the second orientation (see below) of the bayonet fitting (1) in relation to the attachment support (21), there is no significant dip or rise caused by the flat outer facing side (9) of the base section with respect to the surface of the reactor lumen facing side (22) of the attachment support (21), as the attachment support is traversed across a domed bayonet recess (24) which is housing a bayonet fitting (1).

A second orientation of the bayonet fitting (1) in relation to the attachment support (20) is achieved when the bayonet fitting (1) that has passed through the bayonet cut-out (25) (to the extent possible until its passage is impeded by the inner facing side (8) of the base section), is rotated up to 90° around the longitudinal axis of the bayonet fitting (A-A).

The domed bayonet recess (24) further comprises more than one dimple (26), each of which is a crater-like depression in lumen-facing surface of the the domed bayonet recess (24). The number of more than one dimple (26) is the same as the number of more than one protuberance (7) present on the bayonet fitting.

The transition from the first orientation to the second orientation comprises a rotation up to 90°. Preferably, the rotation is in a clockwise direction, although an anti-clockwise rotation is not precluded.

The gradient on the fourth side is oriented such that the side of the fourth side (15) where the apex (14) is located is closer to the inner facing side (8) of the base section, than on its other (non-apex) side. This provides the leading edge to the gradient of the fourth side (15).

During the transition from the first orientation to the second orientation, the side of the fourth side (15) without the apex (non-apex side) begins to rotate away from the bayonet cut-out (25), and begins to travel over the surface of the domed bayonet recess (24) of the attachment support. Thus, the leading edge of the fourth side enables the domed bayonet recess (24) of the attachment support move into the clamping section (13) of the bayonet fitting, initially without any impedance.

If the transition from the first orientation to the second orientation comprises an anti-clockwise rotation, the leading edge is oriented such that during the transition from the first orientation to the second orientation, the side of the fourth side (15) without the apex also begins to rotate away from the bayonet cut-out (25), and begins to travel over the wall of the domed bayonet recess (24) of the attachment support.

The continuation of the rotation from the first orientation to the second orientation engages the more than one protuberance (7) with the lumen-facing wall of the domed bayonet recess (24) of the attachment support, as well as enabling the apex (14) to touch and engage the non-lumen-facing wall of the of the domed bayonet recess (24) of the attachment support.

During the rotation from the first orientation to the second orientation, the engagement of the more than one protuberance (7) with the wall of the domed bayonet recess occurs before the engagement of the apex (14).

The height H3 of the clamping section (13) is the same as the plate thickness of the attachment support (21), subject to any plate thickness tolerance.

The rotation of the bayonet fitting (1) from the first orientation to the second orientation around the bayonet cut-out (25), requires a maximum torque value ranging from 2 Nm to 3 Nm, and therefore generally can be carried out by hand, avoiding the use of any tools, although the use of any tools is not precluded.

During the initial part of the transition from the first orientation to the second orientation (as the side of the fourth side (15) without the apex (i.e. the non-apex side) begins to move rotationally away from the bayonet cut-out (25) and over the wall of the domed bayonet recess (24) of the attachment support), the torque required to effect the rotation in negligible, as the gap provided by the leading edge (i.e. the non-apex side) is wider than the height H3 of the clamping section (13), and also wider than the plate thickness of the attachment support, thus enabling the wall of the domed bayonet recess to enter the clamping section (13) unimpeded.

During the rotation, as the more than one protuberance (7) touch and engage the wall of the domed bayonet recess (24) of the attachment support, the torque required for the rotation increases up to a value ranging from 2 Nm to 3 Nm. As the rotation continues, each of the more than one protuberance (7) engage with, and begin to move into, each of the more than one dimple (26), which results in each of the more than one protuberance (7) clicking into, and being accommodated within, each of the more than one dimple (26). The accommodation of the more than one protuberance (7) within each of the more than one dimple (26) is reversible, i.e. each of the more than one protuberance (7) is accommodable within each of the more than one dimple (26). Further rotation, either clockwise or anti-clockwise, with the application of a torque of above 3 Nm will enable the disengagement of the more than one protuberance (7) from the more than one dimple (26).

Continuation of this rotation up to 90° from the second orientation will bring the more than one flange to the bayonet cut-out (25) and the bayonet fitting (1) can be removed out of the domed bayonet recess (24).

The torque required to disengage the more than one protuberance (7) from the more than one dimple (26) is sufficient for the bayonet assembly to remain attached together, unless intended human induced action disengages it.

The plateau region and the corrugated region comprising the at least one ridge, groove and/or a wrinkle assists in the transition from the first orientation to the second orientation of the bayonet fitting (1) by enabling the bayonet fitting (1) to rest with reduced lateral movement within the domed bayonet recess (24) at an axis that is substantially 90° to the flat plane of the attachment support, and aligned to enable the clamping section to begin to engage with and accommodate the wall of the bayonet recess.

The at least one ridge, groove and/or a wrinkle also act like a bellows, and provide mechanical flexibility to the wall of the bayonet recess along the longitudinal axis of the bayonet fitting (A-A), such that any thermal expansion or contraction by the bayonet fitting (1) is accommodated. This is particularly so during thermal changes of the reactor or column, and protects against thermally induced deformation.

To further protect against thermally induced deformation, the bayonet fitting (1) and attachment support (21) may be made of the same material, for example, steel, although other materials are not precluded.

The invention additionally relates to the use of a bayonet fitting (1) for the reversible attachment and detachment of internals within reactor vessels and distillation columns.

The invention further relates to the use of a bayonet assembly (20), for the reversible attachment and detachment of internals within reactor vessels and distillation columns.

Once the bayonet assembly is in the second orientation, internals are reversable attachable to, and detachable from, the bayonet assembly.

To enable the reversible attachment of internals to the bayonet assembly, each attachable internal comprises an oblong-profiled hole, through which the tail section of the fifth and the sixth embodiments of the bayonet fitting is passable.

In the case of the fifth embodiment, the reversable attachment of an internal to the bayonet assembly comprises the placement of the tail section into the oblong hole of the internal, and the insertion of a split-key (42) through the hole of the arch of the tail section. Once an internal is fitted onto the tail section, and rests against the flat outer facing side (9) of the base section, a split-key (42) may be inserted through the hole of the arch of the tail section. Split-key (42) is a wedge-like piece comprising a head part perpendicularly oriented to the wedge part, which when inserted into the arch of the tail section impedes the further passage of the split-key, and locks the split key in the arch of the tail section. To remove the internal, the split-key can be pulled out from the arch of the tail section, and the internal pulled off the tail section.

In the case of the sixth embodiment, the screw-threaded stud bolt tail section is also passable through the oblong hole of internals. The reversable attachment of an internal to the bayonet assembly comprises the placement of the tail section into the oblong hole of the internal until the internal rests against the flat outer facing side (9) of the base section. Secure attachment of an internal to the sixth embodiment further comprises the use of a washer and nut assembly that is secured onto the screw-threaded tail section. Removal of the internal comprises the unscrewing of the washer-nut assembly.

Attachment internals is not possible in the case of the fourth embodiment, as the latter does not possess a tail section. The fourth embodiment is useful for plugging unused domed bayonet recesses.

### DETAILED DESCRIPTION OF THE DRAWINGS

FIG. 1 illustrates perspective view of the first embodiment of the bayonet fitting (1) according to the present invention, showing a head section (2), and a base section (3), wherein the head section (2) and the base section (3) are a contiguous single piece. The bayonet fitting (1) may further comprise a tail section (4). The head section (2) comprises a cylindrical core (5), from the circumferential surface (12) of which more than one flange (6) protrude radially.

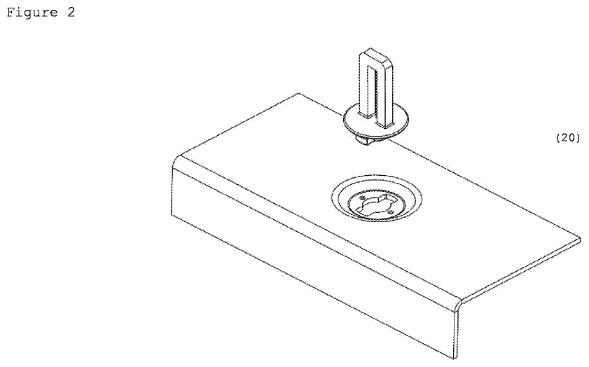

FIG. 2 illustrates perspective view of an embodiment of the bayonet assembly (20) according to the present invention.

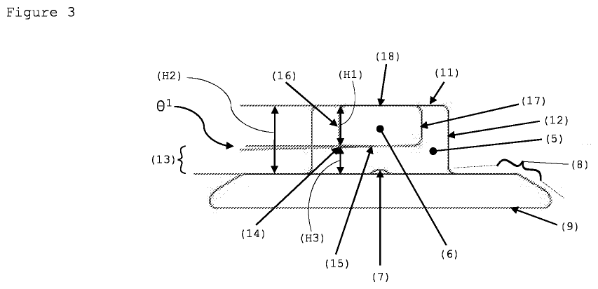

FIG. 3 illustrates two side views of the first embodiment of the bayonet fitting (1) according to the present invention, showing a side view of the head section (2) and the base section (3).

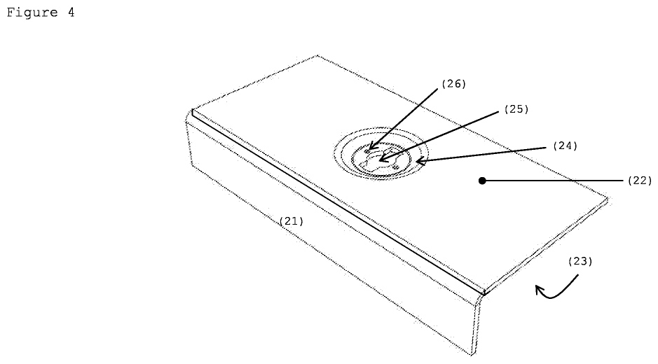

FIG. 4 illustrates perspective view of attachment support (21) according to the present invention. The attachment support (21) comprises a reactor lumen facing side (22), a reactor casing facing side (23) and a domed bayonet recess (24). The domed bayonet recess (24) is a cavity that dips from the reactor lumen facing side (22) of the attachment support towards the reactor casing facing side (23) of the attachment support. The domed bayonet recess (24) comprises a bayonet cut-out (25) and more than one dimple (26).

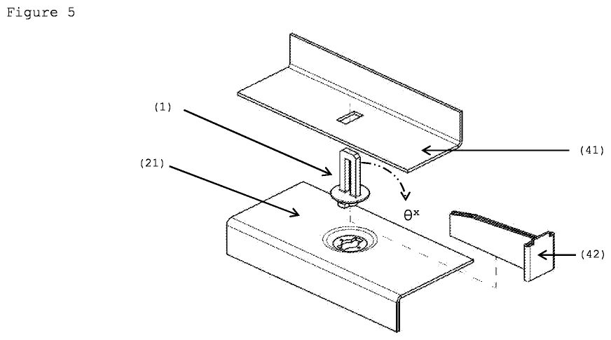

FIG. 5 illustrates perspective view of the fifth embodiment of the bayonet fitting (1) according to the present invention, wherein the tail section is an arch, through which its split key (42) can be reversibly placed. The figure also illustrates an attachment support (21), as well as an internal (41). Once inserted into the bayonet cut-out, the bayonet fitting may be rotated around its longitudinal axis to lock it into place. The dashed arrow illustrates a rotation around the longitudinal axis of the bayonet fitting, parallel to the flat reactor lumen facing side (22) of the attachment support (21).

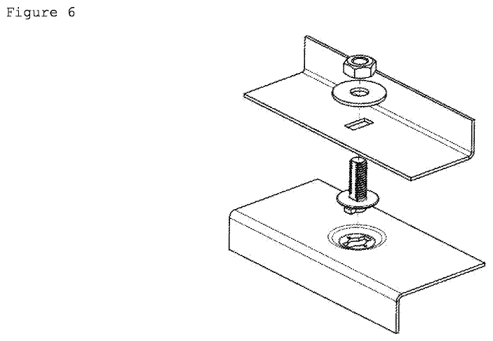

FIG. 6 illustrates perspective view of the sixth embodiment of the bayonet fitting (1) according to the present invention, wherein the tail section is a stud bolt, to which standard washer(s) and nut(s) may be fitted/threaded onto. The screw-threaded body of the stud bolt comprises two parallel sections wherein the screw thread is shaved off along the screw-threaded body's longitudinal axis.

### EXAMPLES

The invention will now be described by reference to examples which are not intended to be limiting of the invention.

### Example 1

The dimensions of a bayonet assembly (20) according to the present invention is described below:

The dimensions of a bayonet fitting (1), with reference to a plan view along the longitudinal axis of the bayonet fitting (A-A), wherein the bayonet fitting (1) has more than one flange (6) and more than one protuberances (7):
diameter of the base section (3): 25 mm
diameter of the cylindrical core (5): 10 mm
width of a more than one flange (6): 6 mm
distance between the tips of flanges (6): 17 mm
distance between two more than one protuberance (7): 15 mm

The dimensions of a bayonet fitting (1), in reference to a side view perpendicular to the longitudinal axis of the bayonet fitting (A-A):
diameter of the base section (3): 25 mm
thickness of the base section (3) along longitudinal axis of the bayonet fitting (A-A): 2.5 mm
gradient (θ¹) angle of the more than one flange (6): 5°

The dimensions of a domed bayonet recess (24) in reference to a plan view, wherein the domed bayonet recess (24) is for receiving a bayonet fitting (1) with two more than one flange (6) and two more than one protuberances (7):
outer diameter of the domed bayonet recess (24): 35 mm;
width of the bayonet cut-out (25) for receiving a more than one flange (6): 6.5 mm;
distance between the tips of the bayonet cut-out (25) for receiving the more than one flange (6): 18 mm;
diameter of the circular hole of the bayonet cut-out (25) for receiving the cylindrical core (5): 11 mm
distance between the two more than one dimple (26): 15 mm;
depth of inside domed bayonet recess (24) from the reactor casing facing side (23): 3 mm.

1. A bayonet fitting (1) comprising a head section (2), a base section (3), and a clamping section (13);
wherein the head section (2) and the base section (3) and the clamping section are a single contiguous piece;
wherein the head section (2) comprises a cylindrical core (5) that protrudes along the longitudinal axis (A-A) of the bayonet fitting;
wherein the cylindrical core (5) comprises more than one flange (6) protruding radially from the circumferential surface (12) of the cylindrical core (5) in a direction perpendicular to the longitudinal axis of the bayonet fitting;
wherein each of the more than one flange (6) comprises the clamping section (13) and an apex (14);
wherein the base section (3) comprises an inner facing side (8) from which the cylindrical core (5) protrudes, and an outer facing side (9) that faces the opposite direction to the cylindrical core (5) along the longitudinal axis of the bayonet fitting (A-A);
wherein the surface profile of the inner facing side (8) is convex;
wherein the surface profile of the outer facing side (9) is flat;
wherein the inner facing side (8) further comprises more than one protuberance (7) emerging off the inner facing side (8) in a direction parallel to the longitudinal axis of the bayonet fitting (A-A);
wherein the apex points towards the inner facing side (8) of the base section; and
wherein the clamping section (13) comprises the apex (14), the inner facing side (8) of the base section (3) and a protuberance (7).

2. The bayonet fitting according to claim 1, wherein the bayonet fitting further comprises a tail section (4) that protrudes from the outer facing side (8) of the base section (3) in a direction opposite to the head section along the longitudinal axis of the bayonet fitting (A-A), and the head section (2), the base section (3) and the tail section (4) are a contiguous single piece.

3. The bayonet fitting according to claim 2, wherein the tail section (4) is selected from an arch or a stud bolt.

4. A bayonet assembly (20) comprising the bayonet fitting (1) according to claim 1 and an attachment support (21);
wherein the attachment support (21) comprises a domed bayonet recess (24), a bayonet cut-out (25), and more than one dimple (26);
wherein the number of more than one dimple (26) of the bayonet assembly is the same as the number of more than one protuberance (7) of the bayonet assembly;
wherein in a first orientation the bayonet fitting (1) and the attachment support (21) are detachable from each other, and in a second orientation the bayonet fitting (1) and the attachment support (21) are lockable to each other; and
wherein in the second orientation, each of the more than one dimple (26) reversibly accommodates each of the more than one protuberance (7).

5. The bayonet assembly according to claim 4, wherein the bayonet assembly further comprises an internal (41) comprising an oblong hole.

6. The bayonet assembly according to claim 5, wherein the bayonet assembly further comprises a split-key (42) or a nut attachable to the tail section.

7. The use of bayonet fitting according to claim 1 for the reversible attachment and detachment of internals within reactor vessels, distillation columns and mass transfer units.

8. The use of bayonet assembly according claim 4 for the reversible attachment and detachment of internals within reactor vessels, distillation columns and mass transfer units.
